(19) United States
(12) Patent Application Publication
(10) Pub. No.: US 2010/0223821 A1
(43) Pub. Date: Sep. 9, 2010

(54) GREETING CARD STRUCTURE AND A METHOD OF MAKING A GREETING CARD STRUCTURE

(76) Inventor: PERRY CHARLES BOGAL, Scottsdale, AZ (US)

Correspondence Address: MICHAEL WINFIELD GOLTRY, 4000 N. CENTRAL AVENUE, SUITE 1220, PHOENIX, AZ, 85012, US

(21) Appl. No.: 12/396,771

(22) Filed: Mar. 3, 2009

(51) Int. Cl. G09F 1/04; B23P 17/04; G09F 1/00

(52) U.S. Cl. 40/124.06; 29/428

(57) ABSTRACT

A greeting card has an outside and an inside, and pre-applied indicia applied to the inside of the greeting card relating to a subject matter. A quantity of material relating to the subject matter is contained in a small packet, which is secured to the inside of the greeting card. A fold is formed in the greeting card to allow movement of the greeting card at the fold between a closed position closing the inside of the greeting card substantially enclosing quantity of material contained in the small packet secured to the inside of the greeting card, and an open position opening the inside of the greeting card exposing the quantity of material contained in the small packet secured to the inside of the greeting card.

### FIELD OF THE INVENTION

The present invention relates to greeting cards.

### BACKGROUND OF THE INVENTION

A greeting card is an illustrated card featuring an expression of friendship, thanks or other sentiment or feeling. Many greeting cards are folded allowing for opening and closing, while some are not, and still others can included multiple folds and even features that pop up when the card is opened. Greeting cards can relate to any subject matter, whether a theme or occasion, including birthdays, Easter, Thanksgiving, Christmas, or other subject matter. Greeting cards of often packaged in an envelope, and come in a variety of styles.

A standard greeting card is printed on high-quality paper or card stock, and is rectangular and folded, with a picture or decorative motif on the front of the card. Inside the card is a preprinted message appropriate to the occasion, along with a blank space for the sender to add a signature or handwritten message. A matching envelope is sold with the card. Some cards and envelopes feature fancy materials, such as gold leaf, ribbons, or glitter.

Greeting cards are used prevalently to convey greetings and best wishes to friends, family, and colleagues. Regardless of the type of greeting card, a typical greeting card incorporates indicia that relates to a particular subject matter, such as a particular occasion or event, such as birthdays, Halloween, Thanksgiving, Christmas, Easter, or the like, or a particular theme, place, or the like. Regardless of the subject matter that a greeting card relates to as defined by the selected indicia applied to the card, most incorporate pictures, drawings, messages, and/or decorative motifs relating to, or otherwise defining, the subject matter of the card. Although such greeting cards are fun and suitable, it would be highly desirable to improve the appeal and functionality of greeting cards that include messages and motifs relating to a particular type of subject matter.

### SUMMARY OF THE INVENTION

According to the principle of the invention, a greeting card structure includes a greeting card having pre-applied indicia relating to a subject matter, and a quantity of material relating to the subject matter contained in a small packet secured to the greeting card. In a particular embodiment, the subject matter of the pre-applied indicia is an occasion relating to winter, and the quantity of material contained in the small packet secured to the greeting card relating to the subject matter is artificial snow material. The small packet is preferably formed of thin, pliant material, such as plastic film or the like. The thin, pliant material is preferably transparent to allow the quantity of material contained in the small packet to be seen therethrough. A closure is formed in the small packet, which is disposed in a closed position closing the small packet containing the quantity of material in the small packet. The closure is movable from the closed position to an open position opening the small packet to permit the quantity of material to be dispensed from the small packet. An adhesive applied between the greeting card and the small packet secures the small packet to the greeting card.

According to the principle of the invention, a greeting card structure includes a greeting card having an outside and an inside, and pre-applied indicia applied to the greeting card relating to a subject matter. In this embodiment, the pre-applied indicia are applied to the inside of the greeting card. A quantity of material relating to the subject matter of the pre-applied indicia is contained in a small packet. The small packet is secured to the greeting card, and preferably to the inside of the greeting card. A fold is formed in the greeting card to allow movement of the greeting card at the fold between a closed position closing the inside of the greeting card substantially enclosing the small packet containing the quantity of material secured to the inside of the greeting card, and an open position opening the inside of the greeting card exposing the small packet containing the quantity of material secured to the inside of the greeting card. Preferably, the small packet is formed of thin, pliant material, such as thin plastic film or the like. The thin, pliant material is preferably transparent to allow the quantity of material contained in the small packet to be seen therethrough. A closure is formed in the small packet, which is disposed in a closed position closing the small packet containing the quantity of material in the small packet. The closure is movable from the closed position to an open position opening the small packet to permit the quantity of material to be dispensed from the small packet. Preferably, an adhesive is applied between the greeting card and the small packet securing the small packet to the greeting card.

According to the principle of the invention, a method includes steps of providing a greeting card having pre-applied indicia relating to a subject matter, providing a small packet containing a quantity of material relating to the subject matter, and securing the small packet to the greeting card. In a particular embodiment, the subject matter of the pre-applied indicia is an occasion relating to winter, and the quantity of material contained in the small packet secured to the greeting card relating to the subject matter is artificial snow material. The method next includes forming the small packet with a closure disposed in a closed position closing the small packet enclosing the quantity of material in the small packet, and which is movable from the closed position into an open position opening the small packet to permit the quantity of material to be dispensed from the small packet. In a preferred embodiment, the step of securing the small packet to the inside of the greeting card further includes adhesively securing the small packet to the inside of the greeting card.

According to the principle of the invention, a method includes steps of providing a greeting card having an outside and an inside, pre-applied indicia applied to the inside of the greeting card relating to a subject matter, and a fold formed in the greeting card. The method next includes providing a small packet containing a quantity of material relating to the subject matter of the pre-applied indicia, and securing the small packet to the inside of the greeting card, in which the fold formed in the greeting card allows movement of the greeting card at the fold between a closed position closing the inside of the greeting card substantially enclosing the small packet secured to the inside of the greeting card containing the quantity of material, and an open position opening the inside of the greeting card exposing the small packet secured to the inside of the greeting card containing the quantity of material. In a particular embodiment, the subject matter of the pre-applied indicia is an occasion relating to winter, and the quantity of material contained in the small packet secured to the greeting card relating to the subject matter comprises artificial snow material. Further to the present method is the step forming a closure in the small packet, which is disposed in a closed position closing the small packet enclosing the quantity of material in the small packet, and which is movable from the closed position into an open position opening the small packet to allow the quantity of material to be dispensed from the small packet. The step of securing the small packet to the inside of the greeting card preferably includes adhesively securing the small packet to the inside of the greeting card.

### BRIEF DESCRIPTION OF THE DRAWINGS

Referring to the drawings:

FIG. 1 is a perspective view of a greeting card structure including a greeting card formed with pre-applied indicia relating to a subject matter, and an attached small packet containing a quantity of material relating to the subject matter of the indicia, the greeting structure constructed and arranged in accordance with the principle of the invention and show at it would appear in an open position;

FIG. 2 is a front perspective view of the greeting card structure of FIG. 1 shown as it would appear in a closed position;

FIG. 3 is an end elevation view of the greeting card structure of FIG. 1 shown as it would appear in a closed position;

FIG. 4 is a highly generalized view of the greeting card structure of FIG. 1 illustrating the small packet as it would appear detached from the greeting card; and

FIG. 5 is a prior art perspective view of an artificial snow-forming operation illustrating artificial snow material from the small packet and water from a water source shown as they would appear being applied to a mixing bowl and mixed together to form artificial snow.

### DETAILED DESCRIPTION OF PREFERRED EMBODIMENT

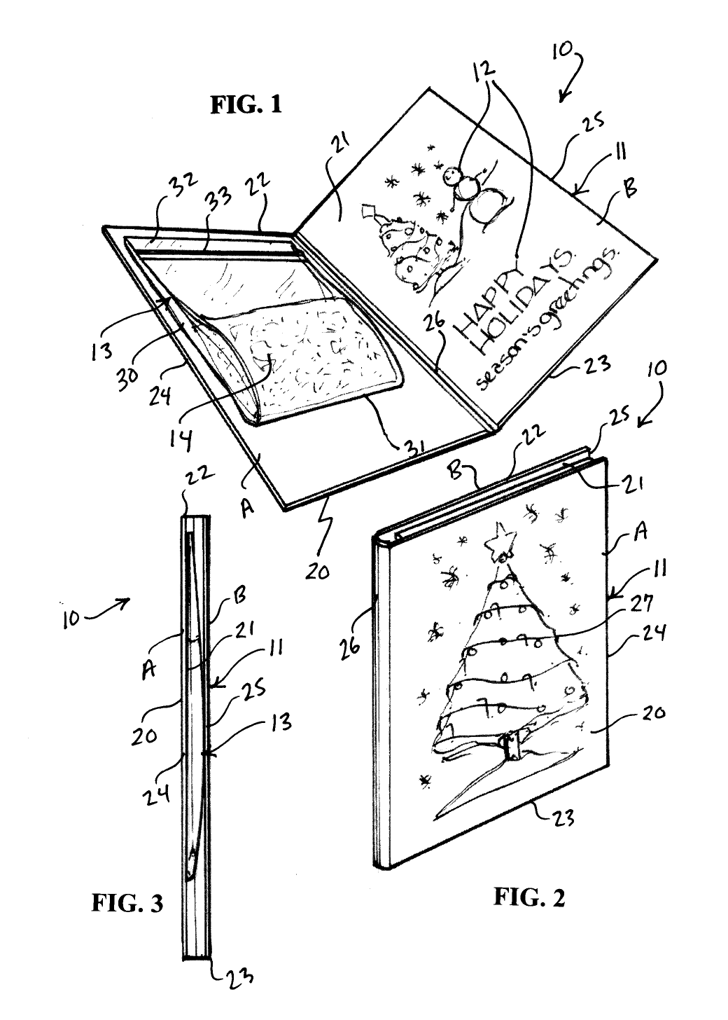

Turning now to the drawings, in which like reference characters indicate corresponding elements throughout the several views, attention is first directed to FIG. 1 in which there is seen a greeting card structure 10 constructed and arranged in accordance with the principle of the invention, including a greeting card 11 formed with indicia denoted generally at 12, and a packet 13 containing a quantity of material 14. Indicia 12 relate to a subject matter, and quantity of material 14, in turn, relates to the subject matter of indicia 12, in accordance with the principle of the invention.

Greeting card 11 is formed of a high-quality paper or card stock or the like, and in the present embodiment is overall substantially rectangular shape. Greeting card 11 has an outside marked by a major outer surface or face 20, an inside marked by a major inner surface or face 21 opposing major outer face 20, opposed parallel upper and lower edges 22 and 23, and opposed parallel side edges 24 and 25. A fold 26 is formed in greeting card 11, which extends from upper edge 22 to lower edge 23, which is disposed at an intermediate location between side edges 24 and 25, and which is parallel with respect to opposed side edges 24 and 25. Fold 26 divides greeting card 11 into two opposed sides, including a top side A and a bottom side B.

In this embodiment, top and bottom sides A and B are substantially equal in size and shape.

Greeting card 11 is movable at fold 26 between a closed position closing the inside of greeting card 11 as illustrated in FIG. 2, and an open position opening the inside of greeting card 11. In the closed position of greeting card 11 illustrated in FIGS. 2 and 3, top side A and bottom side B of greeting card 11 are brought together in juxtaposition with respect to each other bringing inner face 21 of greeting card 11 at top side A toward inner face 21 of greeting card 11 at bottom side B. In the closed position of greeting card 11, top and bottom sides A and B of greeting card 11 are not only brought together, top and bottom sides A and B are parallel with respect to each other and inner face 21 of top side A of greeting card 11 confronts and is parallel with respect to inner face 21 of bottom side B of greeting card 11. In the open position of greeting card 11 illustrated in FIG. 2, top side A and bottom side B of greeting card 11 are moved apart with respect to each other opening or otherwise exposing inner face 21 of each of top and bottom sides A and B of greeting card 11.

Indicia 12 relate to a subject matter, and are applied to greeting card 11. In this embodiment, indicia 12 are applied upon inner face 21 of bottom side B of greeting card 11. As a matter of example and disclosure, indicia 12 are characterized by markings. The markings forming indicia 12 are pre-applied or otherwise pre-printed on inner face of bottom side B of greeting card 11.

In a preferred embodiment set forth herein by way of example, the subject matter of indicia 12 is an occasion relating to snow or winter or otherwise conveys a greeting or message appropriate to an occasion relating to snow or winter, in accordance with the principle of the invention. The markings forming or otherwise characterizing indicia 12 in the present embodiment include, as a matter of example, a motif consisting of a snowman and a Christmas tree and snowflakes as clearly illustrated, in conjunction with the message or wording “HAPPY HOLIDAYS” positioned over the message or wording “season's greetings”. Indicia 12 is an example of a Christmas greeting functioning to offer a greeting or message appropriate to Christmas that falls within the winter season that is typically characterized or otherwise associated with the onset of snowy weather. Consistent with the teachings of the invention, the subject matter of indicia 12 can take on any form suitable for conveying a greeting or message appropriate to an occasion relating to winter, which is a season characterized or otherwise associated with snow and snowy weather. Indicia 12 may include coloring, letters, symbols, or other like or desired markings sufficient to convey a greeting or message appropriate to an occasion relating to winter. Although indicia 12 are applied or pre-printed in this embodiment upon inner face 21 of bottom side B of greeting card 11, indicia 12 may be applied or pre-printed upon inner face 21 of top side A of greeting card 11, and in another embodiment to inner face 21 of both top and bottom sides A and B of greeting card 11.

To further identify greeting card 11 as a Christmas greeting card in the present embodiment, indicia 27 are applied or otherwise pre-printed upon outer face 20 of top side A of greeting card 11 as illustrated in FIG. 2, which is, like indicia 12, appropriate to an occasion relating to snow or winter, in accordance with the principle of the invention. As a matter of example and disclosure, indicia 27 consist of markings denoting a motif consisting of a Christmas tree surrounded by snowflakes, as clearly illustrated. Indicia 27 in this embodiment is an example of a Christmas motif identifying greeting card 11 as a greeting card appropriate to the occasion of Christmas, which falls within the winter season that is characterized or otherwise associated with the onset of snow and snowy weather. Consistent with the teachings of the invention, indicia 27 can take on any form suitable for conveying a greeting or message appropriate to an occasion relating to winter, which is a season characterized or otherwise associated with snow and snowy weather. Indicia 27 may include coloring, letters, symbols, or other like or desired markings sufficient to convey a greeting or message appropriate to an occasion relating to winter. If desired, a selected form of indicia appropriate to an occasion relating to winter may be applied to outer face 20 of bottom side B of greeting card 11.

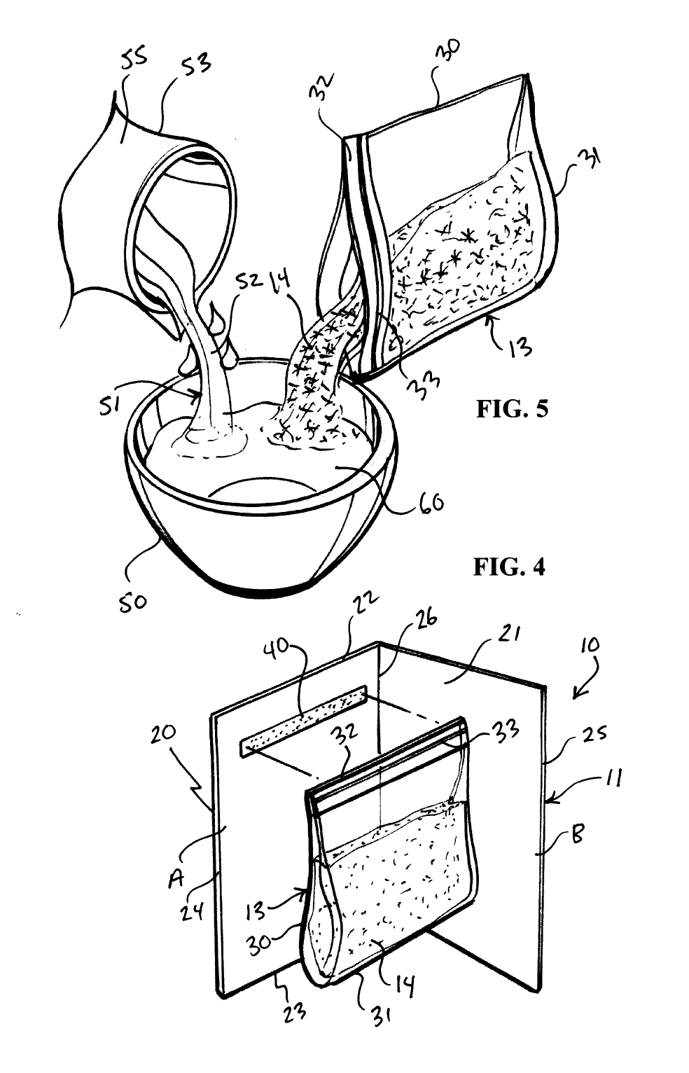

Referencing FIGS. 1, 4, and 5, packet 13 is a small vessel or receptacle consisting of a continuous sidewall 30 including a closed lower end 31 and an opposed upper end 32 formed with a closure 33 movable between a closed position illustrated in FIGS. 1 and 4 closing upper end 32 and an open position illustrated in FIG. 4 opening upper end 32. Formed with closure 33, end 32 is an openable and a closable upper end 32. In the present embodiment, packet 13 is formed of thin, pliant material, such as plastic film or the like, and closure 33 is a conventional and well-known zip or zip-like closure used prevalently in conjunction with conventional plastic storage bags or packets. The thin, pliant material forming packet 13 is preferably transparent to allow the contents contained in packet 13 to be seen through packet 13.

Referencing FIGS. 1 and 4, packet 13 contains quantity of material 14 that, according to the principle of the invention, relates to the subject matter of indicia 12. The subject matter of indicia 12 is an occasion relating to snow or winter in the present embodiment, and quantity of material 14 relating to the occasion relating to snow or winter forming the subject matter of indicia 12 is artificial snow material. The artificial snow material forming quantity of material 14 is an entirely conventional and readily available white, powdery, chemical preparation that when mixed with a quantity of water expands to many times its original volume producing artificial snow or otherwise an artificial snow-like mass, which is white and fluffy and has the texture and look or real snow. Such artificial snow material is commonly found under the trademark MAGICSNOW.

In forming greeting card structure 10, quantity of material 14 is provided, closure 33 is opened to open upper end 32 of packet 13, quantity of material 14 is applied into packet 13 through the open upper end 32 of packet 13, and then closure 33 is closed closing upper end 32 of packet 13 as illustrated in FIGS. 1 and 4 to provide a closed packet 13 of quantity of material 14. To complete formation of greeting card structure 10, packet 13 containing quantity of material 14 is secured to greeting card 11 as illustrated in FIG. 1.

In the present embodiment, packet 13 containing quantity of material 14 is secured to inner face 21 of top side A of greeting card 11 opposing inner face 21 of bottom side B of greeting card 11 formed with indicia 12. Referencing FIG. 4, an adhesive 40 is applied between inner face 21 of top side A of greeting card 11 and packet 13 adhesively securing packet 13 containing quantity of material 14 to inner face 21 of top side A of greeting card 11. In the present example, adhesive 40 is applied in the form of a strip to inner face 21 of top side A of greeting card 11 adjacent to upper edge 22 of greeting card 11 between side edge 24 and fold 26. Upper end 32 of packet 13 is positioned across adhesive 40 and is pressed onto adhesive 40 to adhesively secure packet 13 containing quantity of material 14 to inner face 21 of top side A of greeting card 11, in which packet 13 extends or otherwise depends downwardly from adhesive 40 along inner face 21 of top side A of greeting card 11 toward lower edge 22.

Packet 13 containing quantity of material 14 is sized with respect to inner face 21 of top side A of greeting card 11 such that it fits within the perimeter or boundary of top side A of greeting card 11 bound by top and bottom edges 22 and 23, side edge 24, and fold 26, as illustrated. Adhesive 40 is sufficiently strong to ensure a sure attachment of packet 13 to greeting card 11, but allows a user to take up packet 13, such as by hand, and peel packet 13 away from greeting card without marring either greeting card 11 or packet 13. As such, adhesive 40 adhesively securing packet 13 to greeting card 11 is exemplary of a detachably engagement. Moreover, adhesive 40 can be positioned at any selected location between inner face 21 of top side A of greeting card 11 and packet 13 to adhesively secure packet 13 to inner face 21 of top side A of greeting card.

Having described the structure of greeting card structure 10 as illustrated in FIG. 1, greeting card structure 10 is prepared and ready to be sent to a selected recipient, such as in an envelope, for the recipient to enjoy. Before sending greeting card structure 10 to a selected recipient, the sender of greeting card structure 10 may, if desired, add a signature and/or personal message, such as a handwritten message or printed message, typically on the inside of greeting card 11.

In general, the structure of greeting card structure 10 formed in FIG. 1 includes greeting card 11 having an outside formed by outer face 20 and an inside formed by inner face 21, indicia 12 applied to the inside of greeting card 11 and which relates to a subject matter, and packet 13 containing quantity of material 14 that, in turn, relates to the subject matter of indicia 12. And further to the embodiment depicted in FIG. 1 is fold 26 formed in greeting card 11 to allow movement of greeting card at fold 26 between the closed position illustrated in FIGS. 2 and 3 closing the inside of greeting card 11 thereby substantially enclosing packet 13 secured to the inside of greeting card 11 containing quantity of material 14, and an open position illustrated in FIG. 1 opening the inside of greeting card 11 exposing packet 13 secured to the inside of greeting card 11 containing quantity of material 14.

With packet 13, containing quantity of material 14, secured to inner face 21 of top side A of greeting card 11, in the closed position of greeting card 11 illustrated in FIGS. 2 and 3, top side A and bottom side B of greeting card 11 are brought together in juxtaposition with respect to each other bringing inner face 21 of greeting card 11 at top side A toward inner face 21 of greeting card 11 at bottom side B locating packet 13 containing quantity of material 14 substantially enclosed between the inner face 21 of greeting card 11 of each of top side A and bottom side B of greeting card 11. In the open position of greeting card 11 illustrated in FIG. 2, top side A and bottom side B of greeting card 11 are moved apart with respect to each other opening or otherwise exposing inner face 21 of each of top and bottom sides A and B of greeting card 11 and packet 13 containing quantity of material 14, in accordance with the principle of the invention.

Upon receiving greeting card structure 10, the recipient may open greeting card 11 exposing the inside of greeting card 11 thereby exposing indicia 12, any signature and/or personal message, and packet 13 containing quantity of material 14 that relates to the subject matter of indicia 12. Because packet 13 is preferably transparent, the contents of packet 13, namely, quantity of material 14, may be seen through packet 13. At this point, the recipient may pull packet 13 away from the inside of greeting card 13 detaching packet 13 from adhesive 40 illustrated in FIG. 4. The recipient may pull upper end 32 apart to pull closure 33 apart to open upper end 32 and use the artificial snow material forming quantity of material 14 to create artificial snow by, as illustrated in FIG. 5, providing a mixing bowl 50, dispensing a quantity 51 of water 52 into mixing bowl 50 from a source 53 of water 52, which, in this instance, consists of a container 55 of water 52, dispensing quantity of material 14 into quantity 51 of water 52 through open upper end 32 of packet 13, and mixing quantity of material 14 with quantity 51 of water 52 to produce artificial snow 60, which may be taken up and use by the recipient for whatever selected purpose.

And so indicia 12 relate to a subject matter relating to an occasion relating to snow or winter, and quantity of material 14 is artificial snow material that not only relates to the subject matter of indicia 12 but also is used to make artificial snow 60 in the present embodiment. The provision of indicia 12 defining subject matter relating to an occasion relating to snow or winter, quantity of material 14 being is artificial snow material that not only relates to the subject matter of indicia 12 but also is used to make artificial snow 60 in the present embodiment and which is contained in packet 13 attached to greeting card 11 forms a highly useful greeting card structure 10 that is interesting, more dynamic, and useful as compared to conventional greeting cards. The artificial snow material forming quantity of material 14 in the present embodiment relates or otherwise cooperates with indicia 12 because indicia 12 has the function of being appropriate to an occasion relating to snow or winter or otherwise conveys a greeting or message appropriate to an occasion relating to snow or winter, and because the artificial snow material, in turn, is a physical facsimile of artificial snow and that is useful in making artificial snow 60 by mixing quantity of material 14 with quantity 51 of water 52, in accordance with the principle of the invention. Providing greeting card 11 with indicia 12 that is appropriate to an occasion relating to snow or winter or otherwise conveys a greeting or message appropriate to an occasion relating to snow or winter in combination with the artificial snow material forming quantity of material 14, which is a physical facsimile of artificial snow and that is useful in making artificial snow 60, is equally appropriate to an occasion relating to snow or winter, whereby the combination in a greeting card of indicia 12 and the artificial snow material forming quantity of material 14 in packet 13 cooperate to provide a unique greeting card structure 10, in accordance with the principle of the invention. Because indicia 27 also is appropriate to an occasion relating to snow or winter or otherwise conveys a greeting or message appropriate to an occasion relating to snow or winter, the combination in greeting card 11 of indicia 27 and the artificial snow material forming quantity of material 14 in packet 13 is equally beneficial and cooperate or otherwise work together in the same manner as indicia 12 and quantity of material 14 in packet.

According to the principle of the invention, indicia 12, including indicia 27 in the present embodiment, relate to a subject matter, and quantity of material 14, in turn, relates to the subject matter of indicia 12, and also indicia 27. According to the principle of the invention, the subject matter of indicia 12, and also indicia 27, can be any subject matter, and quantity of material 14 can be any material that relates to the specified subject matter of indicia 12 and/or indicia 27. As a matter of example of this teaching, in a particular embodiment of the invention the subject matter can relate to Easter, and the quantity of material can be a quantity of tiny artificial Easter eggs. In another embodiment of the invention the subject matter can relate to the moon, and the quantity of material can be a quantity of artificial moon dust. In another embodiment of the invention the subject matter can relate to a planet, such as the planet Mars, and the quantity of material can be a quantity of artificial planet dust, or artificial Mars dust. In another embodiment of the invention the subject matter can relate to an occasion relating to the season of fall, and the quantity of material can be a quantity of tiny artificial fall tree leaves. In yet another embodiment of the invention the subject matter can relate to an animal having fur, and the quantity of material can be a quantity of fur of the animal, whether real fur or fake fur relating to the animal. Any subject matter and corresponding quantity of material can be used in conjunction with greeting card structure 10 without departing from the invention.

The invention has been described above with reference to a preferred embodiment. However, those skilled in the art will recognize that changes and modifications may be made to the embodiment without departing from the nature and scope of the invention. Various changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A greeting card structure, comprising:
a greeting card having pre-applied indicia relating to a subject matter; and
a quantity of material contained in a small packet secured to the greeting card, the quantity of material relating to the subject matter.

2. A greeting card structure according to claim 1, wherein the subject matter of the pre-applied indicia is an occasion relating to winter, and the quantity of material contained in the small packet secured to the greeting card relating to the subject matter comprises artificial snow material.

3. A greeting card structure according to claim 1, wherein the small packet is formed of thin, pliant material.

4. A greeting card structure according to claim 3, wherein the thin, pliant material is transparent to allow the quantity of material to be seen through the small packet.

5. A greeting card structure according to claim 1, further comprising a closure formed in the small packet disposed in a closed position closing the small packet containing the quantity of material in the small packet, the closure movable from the closed position to an open position opening the small packet to permit the quantity of material to be dispensed from the small packet.

6. A greeting card structure according to claim 1, further comprising an adhesive applied between the greeting card and the small packet securing the small packet to the greeting card.

7. A greeting card structure, comprising:
a greeting card having an outside and an inside;
pre-applied indicia applied to the inside of the greeting card relating to a subject matter;
a quantity of material contained in a small packet secured to the inside of the greeting card, the quantity of material relating to the subject matter; and
a fold formed in the greeting card to allow movement of the greeting card at the fold between a closed position closing the inside of the greeting card substantially enclosing the small packet secured to the inside of the greeting card containing the quantity of material, and an open position opening the inside of the greeting card exposing the small packet secured to the inside of the greeting card containing the quantity of material.

8. A greeting card structure according to claim 7, wherein the subject matter of the pre-applied indicia is an occasion relating to winter, and the quantity of material contained in the small packet secured to the greeting card relating to the subject matter comprises artificial snow material.

9. A greeting card structure according to claim 7, wherein the small packet is formed of thin, pliant material.

10. A greeting card structure according to claim 9, wherein the thin, pliant material is transparent to allow the quantity of artificial snow material to be seen through the small packet.

11. A greeting card structure according to claim 7, further comprising a closure formed in the small packet disposed in a closed position closing the small packet containing the quantity of material in the small packet, the closure movable from the closed position to an open position opening the small packet to permit the quantity of material to be dispensed from the small packet.

12. A greeting card structure according to claim 7, further comprising an adhesive applied between the greeting card and the small packet securing the small packet to the greeting card.

13. A method, comprising steps of:
providing a greeting card having pre-applied indicia relating to a subject matter;
providing a small packet containing a quantity of material relating to the subject matter; and
securing the small packet to the greeting card.

14. The method according to claim 13, wherein the subject matter of the pre-applied indicia is an occasion relating to winter, and the quantity of material contained in the small packet secured to the greeting card relating to the subject matter comprises artificial snow material.

15. A method according to claim 13, further comprising forming the small packet with a closure disposed in a closed position closing the small packet enclosing the quantity of material in the small packet, in which the closure is movable from the closed position to an open position opening the small packet to permit the quantity of material contained in the small packet to be dispensed from the small packet.

16. A method according to claim 13, wherein the step of securing the small packet to the inside of the greeting card further comprises adhesively securing the small packet to the inside of the greeting card.

17. A method, comprising steps of:
providing a greeting card having an outside and an inside, pre-applied indicia applied to the inside of the greeting card relating so a subject matter, and a fold formed in the greeting card;
providing a small packet containing a quantity of material relating to the subject matter;
securing the small packet to the inside of the greeting card; and
the fold formed in the greeting card to allow movement of the greeting card at the fold between a closed position closing the inside of the greeting card substantially enclosing the small packet secured to the inside of the greeting card containing the quantity of material, and an open position opening the inside of the greeting card exposing the small packet secured to the inside of the greeting card containing the quantity of material.

18. The method according to claim 17, wherein the subject matter of the pre-applied indicia is an occasion relating to winter, and the quantity of material contained in the small packet secured to the greeting card relating to the subject matter comprises artificial snow material.

19. The method according to claim 17, further comprising forming the small packet with a closure disposed in a closed position closing the small packet enclosing the quantity of material in the small packet, in which the closure is movable from the closed position to an open position opening the small packet to permit the quantity of material contained in the small packet to be disposed therefrom.

20. The method according to claim 17, wherein the step of securing the small packet to the inside of the greeting card further comprises adhesively securing the small packet to the inside of the greeting card.
